(19) United States
(12) Patent Application Publication
(10) Pub. No.: US 2020/0215426 A1
(43) Pub. Date: Jul. 9, 2020

(54) SELF-ADHESIVE STACKED SET

(71) Applicant: Taiwan Hopax Chemicals Mfg. Co., Ltd., Kaohsiung City (TW)

(72) Inventors: Mei-Lin Kuo, Kaohsiung City (TW); Ming-Yang Li, Kaohsiung City (TW); Tzu-Jung Wang, Kaohsiung City (TW); Kai-Wei Shih, Kaohsiung City (TW); Shu-Wei Ho, Kaohsiung City (TW)

(73) Assignee: Taiwan Hopax Chemicals Mfg. Co., Ltd., Kaohsiung City (TW)

(21) Appl. No.: 16/294,924

(22) Filed: Mar. 7, 2019

(30) Foreign Application Priority Data
Jan. 9, 2019 (TW) 108100866

(51) Int. Cl. A63F 9/12; A63F 9/06; B32B 7/12; B32B 27/08; B32B 29/00

(52) U.S. Cl. CPC A63F 9/1208; A63F 9/0669; B32B 7/12; B32B 2307/402; B32B 29/005; A63F 2250/602; A63F 2009/0695; B32B 27/08

(57) ABSTRACT

A self-adhesive stacked set including a plurality of stacked bodies is provided. The plurality of stacked bodies form a three-dimensional geometry, and a top view shape of the plurality of stacked bodies includes a triangle and a quadrangle. Each of the stacked bodies includes a plurality of stacked layers, and the plurality of stacked layers are stacked on each other. A rear surface of each of the stacked layers has an adhesive region, and the plurality of stacked layers are stuck to each other via the adhesive region.

### CROSS-REFERENCE TO RELATED APPLICATION

This application claims the priority benefit of Taiwan application serial no. 108100866, filed on Jan. 9, 2019. The entirety of the above-mentioned patent application is hereby incorporated by reference herein and made a part of this specification.

### BACKGROUND OF THE INVENTION

### Field of the Invention

The invention relates to a stacked set, and particularly relates to a self-adhesive stacked set.

### Description of Related Art

A tangram is an educational toy composed of seven boards, which can be combined into thousands of figures. Thus, the tangram can be used not only to help children learn geometric shapes, but also to help children construct their spatial concepts. At the same time, in the process of arrangement and combination, the creativity and concentration of children can also be enhanced. After thousands of years of development, although the tangram has different evolution and deformation in the world, the basic rules are approximately the same.

At present, wood is the main material of the common tangram. However, the wood tangram can only be arranged in one combination at a time. That is, after the arrangement is completed, it is necessary to restart to carry out the next arrangement and combination, and it is not easy to leave a record after the arrangement is completed. Therefore, how to make the tangram more versatile and enhance its convenience of use is the goal that the technicians in this field are eager to improve.

### SUMMARY OF THE INVENTION

The invention provides a self-adhesive stacked set, which can be used as an educational material with both functionality and entertainment, and with the repositionable adhesive and writable functions.

The invention provides a self-adhesive stacked set including a plurality of stacked bodies. The plurality of stacked bodies form a three-dimensional geometry, and a top view shape of the plurality of stacked bodies includes a triangle and a quadrangle. Each of the stacked bodies includes a plurality of stacked layers, and the plurality of stacked layers are stacked on each other. A rear surface of each of the stacked layers has an adhesive region, and the plurality of stacked layers are stuck to each other via the adhesive region.

According to an embodiment of the invention, a number of the plurality of stacked bodies is at least 7.

According to an embodiment of the invention, the plurality of stacked bodies have geometrical shapes of a tangram respectively.

According to an embodiment of the invention, the three-dimensional geometry is a cuboid.

According to an embodiment of the invention, corners of the plurality of stacked bodies are rounded.

According to an embodiment of the invention, the rear surface of each of the stacked layers further has a non-adhesive region.

According to an embodiment of the invention, the non-adhesive region is an area extending inward at least 0.1 cm from at least one edge of each of the stacked layers.

According to an embodiment of the invention, a glue in the adhesive region is fully coated.

According to an embodiment of the invention, a glue in the adhesive region is non-fully coated.

According to an embodiment of the invention, a shape of the glue includes a strip, a dot, or a block.

According to an embodiment of the invention, the block includes a circle, an ellipse, or a polygon.

According to an embodiment of the invention, the adhesive region of the plurality of stacked layers is repositionable adhesive.

According to an embodiment of the invention, the adhesive region of the plurality of stacked layers is non-repositionable adhesive.

According to an embodiment of the invention, a material of the plurality of stacked layers is a writable material.

According to an embodiment of the invention, a material of the plurality of stacked layers includes paper or plastic.

According to an embodiment of the invention, the plurality of stacked bodies are transparent, translucent, or opaque.

According to an embodiment of the invention, the plurality of stacked bodies have different colors.

According to an embodiment of the invention, the colors of the plurality of stacked bodies include yellow, green, pink, or blue.

According to an embodiment of the invention, the colors of the plurality of stacked bodies include fluorescent yellow, fluorescent green, fluorescent pink, or fluorescent blue.

According to an embodiment of the invention, a number of the plurality of stacked layers of each of the stacked bodies is at least 10 layers.

According to an embodiment of the invention, a thickness of each of the stacked bodies is at least 0.1 cm.

According to an embodiment of the invention, the plurality of stacked bodies have geometrical shapes of a tangram respectively, and colors of the plurality of stacked bodies include yellow, green, pink, or blue.

According to an embodiment of the invention, the plurality of stacked bodies have geometrical shapes of a tangram respectively, and colors of the plurality of stacked bodies include fluorescent yellow, fluorescent green, fluorescent pink, or fluorescent blue.

Based on the above, in the self-adhesive stacked set of the invention, the plurality of stacked bodies may form the tangram. Thus, they can be used as the educational material for children, which have the functionality and entertainment. On the other hand, since the stacked layers of each of the stacked bodies have the repositionable adhesive function, when the plurality of stacked bodies are arranged and combined, the position of the arrangement method can be temporarily fixed or the position can be corrected and adjusted easily. Also, after the arrangement and combination is completed, the stacked layers can be further stuck onto a specific target to leave records of the arrangement and combination. Additionally, since the material of the stacked layer is a writable material, the variability and integrity of the overall arrangement and combination can be increased.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a self-adhesive stacked set according to an embodiment of the invention.

FIG. 2 is a schematic three-dimensional structure view of a stacked body of the self-adhesive stacked set in FIG. 1.

FIG. 3A to FIG. 3C are schematic views of a rear surface of a stacked layer according to some embodiments of the invention.

FIG. 4A to FIG. 4E are schematic views of a rear surface of a stacked layer according to some embodiments of the invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

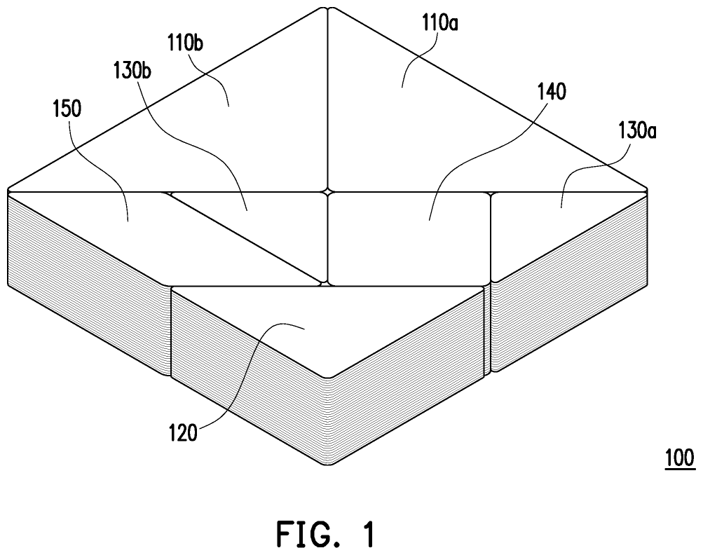

FIG. 1 is a schematic view of a self-adhesive stacked set according to an embodiment of the invention.

Referring to FIG. 1, a self-adhesive stacked set 100 of the present embodiment includes a plurality of stacked bodies, wherein a shape of each of the stacked bodies is not exactly the same. In some embodiments, a top view shape of the plurality of stacked bodies includes, for example, a triangle and a quadrangle. For instance, the triangle includes an equilateral triangle, an isosceles triangle, or a right triangle, for example. The quadrangle includes a square, a rectangle, a diamond, a trapezoid, or a parallelogram, for example. In the present embodiment, the self-adhesive stacked set 100 includes a stacked body 110a, a stacked body 110b, a stacked body 120, a stacked body 130a, and a stacked body 130b of which the top view shape is a triangle, a stacked body 140 of which the top view shape is a square, and a stacked body 150 of which the top view shape is a parallelogram, for example. In some embodiments, the size of the stacked bodies of which the top view shape is a triangle is not exactly the same. For instance, the sizes of the stacked body 110a and the stacked body 110b of which the top view shape is a triangle are relatively large, the sizes of the stacked body 130a and the stacked body 130b of which the top view shape is a triangle are relatively small, and the size of stacked body 120 of which the top view shape is in an intermediate size. However, the invention is not limited thereto. In some embodiments, a number of the plurality of stacked bodies is at least 7, for example. In the present embodiment, the number of the stacked bodies is 7, for example, but the invention is not limited thereto. In a particular embodiment, the plurality of stacked bodies have geometrical shapes of the tangram respectively, for example. In the present embodiment, the plurality of stacked bodies may form a three-dimensional geometry. For instance, the three-dimensional geometry is a cuboid, for example, but the invention is not limited thereto. In other embodiments, the three-dimensional geometry may also be a cube, a cylinder, an egg-shaped cylinder, or an elliptical cylinder.

In some embodiments, corners of the plurality of stacked bodies are rounded, for example, but the invention is not limited thereto. In other embodiments, the corners of the plurality of stacked bodies may also be square. It should be noted that, the design of rounded corners may make the user not easy to be injured, and make the user feel comfortable with the touch of the stacked body. The design of square corners is easy for the user to tear, which is beneficial to the convenience of use. That is, the corners of the stacked body may be adjusted to a suitable design according to the requirements of the user.

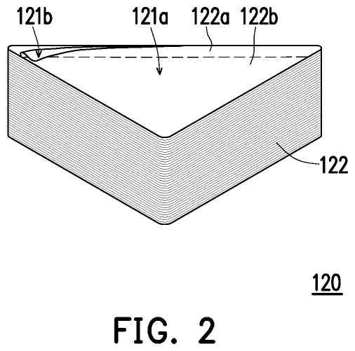

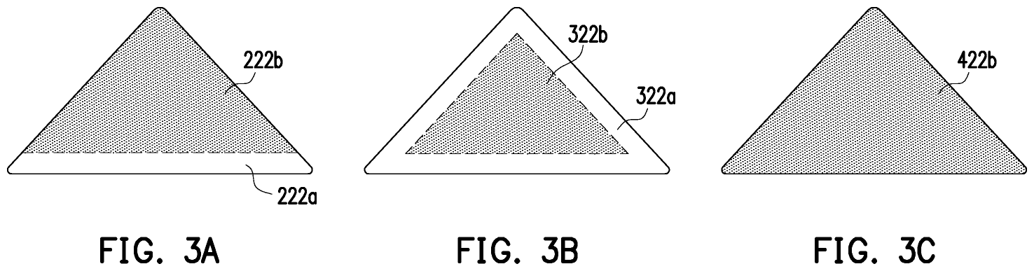

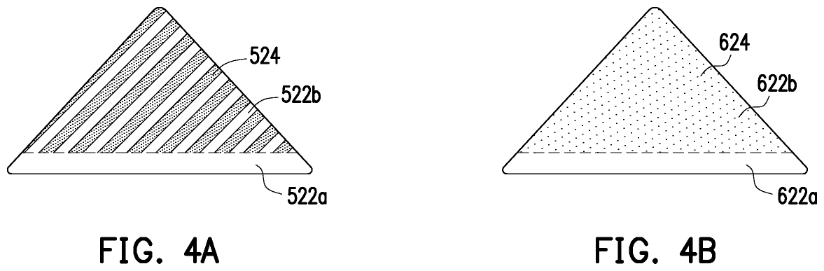

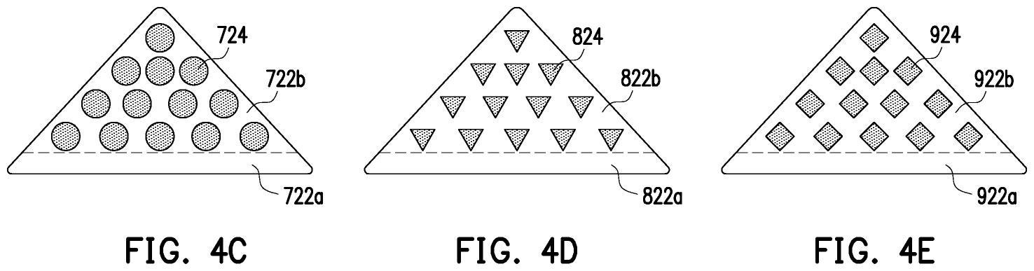

FIG. 2 is a schematic three-dimensional structure view of a stacked body of the self-adhesive stacked set in FIG. 1. FIG. 3A to FIG. 3C are schematic views of a rear surface of a stacked layer according to some embodiments of the invention. FIG. 4A to FIG. 4E are schematic views of a rear surface of a stacked layer according to some embodiments of the invention.

Referring to FIG. 2, in the present embodiment, the stacked body 120 of the self-adhesive stacked set 100 of FIG. 1 is selected for illustration, and the other stacked bodies may have the same or similar features. That is, the description of the following embodiments is illustrated by taking the stacked body of which the top view shape is a triangle as an example, which can be adjusted accordingly when the stacked body of which the top view shapes are other shapes. In the present embodiment, the stacked body 120 has a plurality of stacked layers 122. The plurality of stacked layers 122 are stacked on each other. A rear surface 121b of each of the stacked layers 122 has an adhesive region 122b, and the plurality of stacked layers 122 are stuck to each other via the adhesive region 122b. Specifically, in the present embodiment, the stacked body 120 has the plurality of stacked layers 122. The plurality of stacked layers 122 are stacked on each other. Each of the stacked layers 122 has a front surface 121a and the rear surface 121b. In some embodiments, the rear surface 121b of each of the stacked layers 122 has the adhesive region 122b and a non-adhesive region 122a. The adhesive region 122b is coated with a sticky material thereon, such as a glue, but the invention is not limited thereto. For instance, the non-adhesive region 122a is an area extending inward at least 0.1 cm from at least one edge of each of the stacked layers 122, for example, preferably, between 0.2 cm and 2 cm, for example, more preferably, between 0.5 cm and 1 cm, for example. However, the invention is not limited thereto. In the present embodiment, as shown in FIG. 2, the non-adhesive region 122a is the area extending inward at least 0.1 cm from one edge of each of the stacked layers 122, for example, but the invention is not limited thereto. In some embodiments, the non-adhesive region 122a is located at an edge of each of the stacked layers, for example. In other embodiments, the non-adhesive region 122a is located at or above two edges of each of the stacked layers, for example.

Referring to FIG. 3A, in the present embodiment, a non-adhesive region 222a is the area extending inward at least 0.1 cm from a long side of the stacked layer, for example, and the remaining area is an adhesive region 222b, but the invention is not limited thereto. In other embodiments, the non-adhesive region 222a may also be the area extending inward at least 0.1 cm from a short side of the stacked layer, for example, and the remaining area is the adhesive region 222b. Referring to FIG. 3B, in the present embodiment, a non-adhesive region 322a is the area extending inward at least 0.1 cm from a periphery of the stacked layer, for example, and the remaining area is an adhesive region 322b. In other words, in the present embodiment, the area extending inward at least 0.1 cm from the edges of the triangle is the non-adhesive region 322a. It should be noted that, by the design of non-adhesive region, it is beneficial to enhance the convenience of the user when tearing. Referring to FIG. 3C, in the present embodiment, all the rear surface of the stacked layer may also be an adhesive region 422b, so as to ensure that the stacked layers are completely adhered and flat to avoid warping of the corners. That is, the non-adhesive region of the stacked body may also be adjusted to a suitable design according to the requirements of the user.

In some embodiments, the glue in the adhesive region is fully coated, for example. In other embodiments, the glue in the adhesive region may non-fully coated, for example. In some embodiments, the shape of the glue where the adhesive region is non-fully coated includes a strip, a dot, or a block, for example. In a particular embodiment, the block-shaped glue includes a circle, an ellipse, or a polygon, for example, but the invention is not limited thereto. Referring to FIG. 4A, in the present embodiment, a shape of a glue 524 in an adhesive region 522b is a strip. Referring to FIG. 4B, in the present embodiment, a shape of a glue 624 in an adhesive region 622b is a dot. Referring to FIG. 4C, in the present embodiment, a shape of a glue 724 in an adhesive region 722b is a circle. Referring to FIG. 4D, in the present embodiment, a shape of a glue 824 in an adhesive region 822b is a triangle. Referring to FIG. 4E, in the present embodiment, a shape of a glue 924 in an adhesive region 922b is a square. In FIG. 4A to FIG. 4E, the examples are given of the non-adhesive regions (a non-adhesive region 522a, a non-adhesive region 622a, a non-adhesive region 722a, a non-adhesive region 822a, a non-adhesive region 922a) is the area extending inward at least 0.1 cm from the long side of the stacked layer, but the invention is not limited thereto. It should be noted that, by the design of non-fully coating, it is beneficial to enhance the convenience of the user when tearing. Furthermore, since the stacked layer is easy to tear, and the stacked layer is less likely to be curl after peeling off, the conformability is increased when sticking again.

In some embodiments, the adhesive region of the plurality of stacked layers is repositionable adhesive. That is, after the stacked layer is peeled off the stacked body, the adhesive region of the stacked layer is still sticky, so it can be repeatedly stuck onto any item to facilitate repeatedly sticking to different places. Thus, the convenience of use is increased, and the surface of the object to be stuck is not easily damaged, but the invention is not limited thereto. In other embodiments, the adhesive region of the plurality of stacked layers may be non-repositionable adhesive. That is, the repositionable adhesion of the adhesive region may also be adjusted according to the requirements of the user.

In some embodiments, a material of the stacked layers is a writable material, for example. For instance, the material of the stacked layers includes paper or plastic, for example, but the invention is not limited thereto. In some embodiments, the plurality of stacked bodies are transparent, translucent, or opaque, for example. In some embodiments, the plurality of stacked bodies have different colors. In a particular embodiment, the colors of the plurality of stacked bodies include yellow, green, pink, or blue, for example, but the invention is not limited thereto. In other particular embodiments, the colors of the plurality of stacked bodies include fluorescent yellow, fluorescent green, fluorescent pink, or fluorescent blue, for example, but the invention is not limited thereto. It should be noted that, the stacked bodies of different colors may help the user to identify when arranging and combining, and the overall appearance is increased after the arrangement and combination is completed.

In some embodiments, a number of the plurality of stacked layers of each of the stacked bodies is at least 10 layers, for example, preferably, between 10 layers and 500 layers, for example, more preferably, between 25 layers and 200 layers, for example. However, the invention is not limited thereto. In some embodiments, a thickness of each of the stacked bodies is at least 0.1 cm, for example, preferably, between 0.1 cm and 5 cm, for example, more preferably, between 0.25 cm and 2 cm, for example. However, the invention is not limited thereto.

It should be noted that, the self-adhesive stacked set of the present invention is illustrated by an example of a square tangram, but other deformations of the tangram, such as the deformation of number (e.g., eight tangram, nine tangram, or ten tangram) or the deformation of shape (e.g., heart shape, circle shape, egg shape, or eight trigrams shape), without departing from the spirit and scope of the invention are all within the scope of protection of the invention.

It should be noted that, the stacked bodies of the self-adhesive stacked set of the invention have the functionality and entertainment of the tangram, and can be used as the educational material for children. On the other hand, since the stacked body of the invention is composed of the plurality of stacked layers, the rear surface of each of the stacked layers has the adhesive region to make each of the stacked layers be stuck on each other, and the stacked layer still have the adhesiveness after peeling off the stacked body, the stacked layer may be repeatedly stuck to any item. Thus, when each of the stacked bodies are arranged and combined, the position can be temporarily fixed or the position can be corrected and adjusted easily by the repositionable adhesive function, thereby improving the convenience of use. At the same time, after each of the stacked bodies are arranged and combined to form various geometric shapes (e.g., square, trapezoid, hexagon, or triangle) or specific patterns (e.g., goat, cat, butterfly, tree, car, helicopter, house, snake, whale, dog, flower, or chicken), it can be fixed onto a specific target (e.g., wall, table, or book) by the repositionable adhesive function, which makes it easy for the user to leave the records of the arrangement and combination. Furthermore, since the material of the stacked layer is a writable material, the stacked layer can be written or painted before or after the arrangement and combination of each of the stacked bodies, thereby increasing the variability. For instance, when each of the stacked bodies is arranged into a fish, eyes, a mouth, fins, etc., may be painted on the stacked layers to increase the variability, entertainment, and integrity of the finished product.

In summary, in the self-adhesive stacked set of the invention, the plurality of stacked bodies may form the tangram. Thus, they can be used as the educational material for children, which have the functionality and entertainment. On the other hand, since the stacked layers of each of the stacked bodies have the repositionable adhesive function, when the plurality of stacked bodies are arranged and combined, the position of the arrangement method can be temporarily fixed or the position can be corrected and adjusted easily. Also, after the arrangement and combination is completed, the stacked layers can be further stuck onto a specific target to leave records of the arrangement and combination. Additionally, since the material of the stacked layer is a writable material, the variability and integrity of the overall arrangement and combination can be increased.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A self-adhesive stacked set, comprising a plurality of stacked bodies, the plurality of stacked bodies forming a three-dimensional geometry, and a top view shape of the plurality of stacked bodies comprising a triangle and a quadrangle, wherein each of the plurality of stacked bodies comprises:
a plurality of stacked layers, the plurality of stacked layers being stacked on each other, wherein a rear surface of each of the plurality of stacked layers has an adhesive region, and the plurality of stacked layers are stuck to each other via the adhesive region.

2. The self-adhesive stacked set according to claim 1, wherein a number of the plurality of stacked bodies is at least 7.

3. The self-adhesive stacked set according to claim 2, wherein the plurality of stacked bodies have geometrical shapes of a tangram respectively.

4. The self-adhesive stacked set according to claim 1, wherein the three-dimensional geometry is a cuboid.

5. The self-adhesive stacked set according to claim 1, wherein corners of the plurality of stacked bodies are rounded.

6. The self-adhesive stacked set according to claim 1, wherein the rear surface of each of the plurality of stacked layers further has a non-adhesive region.

7. The self-adhesive stacked set according to claim 6, wherein the non-adhesive region is an area extending inward at least 0.1 cm from at least one edge of each of the plurality of stacked layers.

8. The self-adhesive stacked set according to claim 1, wherein a glue in the adhesive region is fully coated.

9. The self-adhesive stacked set according to claim 1, wherein a glue in the adhesive region is non-fully coated.

10. The self-adhesive stacked set according to claim 9, wherein a shape of the glue comprises a strip, a dot, or a block.

11. The self-adhesive stacked set according to claim 10, wherein the block comprises a circle, an ellipse, or a polygon.

12. The self-adhesive stacked set according to claim 1, wherein the adhesive region of the plurality of stacked layers is repositionable adhesive.

13. The self-adhesive stacked set according to claim 1, wherein the adhesive region of the plurality of stacked layers is non-repositionable adhesive.

14. The self-adhesive stacked set according to claim 1, wherein a material of the plurality of stacked layers is a writable material.

15. The self-adhesive stacked set according to claim 1, wherein a material of the plurality of stacked layers comprises paper or plastic.

16. The self-adhesive stacked set according to claim 1, wherein the plurality of stacked bodies are transparent, translucent, or opaque.

17. The self-adhesive stacked set according to claim 1, wherein the plurality of stacked bodies have different colors.

18. The self-adhesive stacked set according to claim 1, wherein colors of the plurality of stacked bodies comprise yellow, green, pink, or blue.

19. The self-adhesive stacked set according to claim 1, wherein colors of the plurality of stacked bodies comprise fluorescent yellow, fluorescent green, fluorescent pink, or fluorescent blue.

20. The self-adhesive stacked set according to claim 1, wherein a number of the plurality of stacked layers of each of the plurality of stacked bodies is at least 10 layers.

21. The self-adhesive stacked set according to claim 1, wherein a thickness of each of the plurality of stacked bodies is at least 0.1 cm.

22. The self-adhesive stacked set according to claim 1, wherein the plurality of stacked bodies have geometrical shapes of a tangram respectively, and colors of the plurality of stacked bodies comprise yellow, green, pink, or blue.

23. The self-adhesive stacked set according to claim 1, wherein the plurality of stacked bodies have geometrical shapes of a tangram respectively, and colors of the plurality of stacked bodies comprise fluorescent yellow, fluorescent green, fluorescent pink, or fluorescent blue.
